(19) United States
(12) Patent Application Publication
(10) Pub. No.: US 2026/0220369 A1
(43) Pub. Date: Jul. 30, 2026

(54) TEMPERAMENT TUNER

(71) Applicant: Intuit Inc., Mountain View, CA (US)

(72) Inventors: Hadas BAUMER, Tel-Aviv (IL); Omer WOSNER, Modiin (IL); Kobi LEMBERG, Givat - Shmuel (IL); Shahar KEREN, Haifa (IL)

(21) Appl. No.: 19/041,822

(22) Filed: Jan. 30, 2025

(51) Int. Cl. G06F 40/284; G06F 16/335

(52) U.S. Cl. CPC G06F 40/284; G06F 16/335

(57) ABSTRACT

Certain aspects of the disclosure provide techniques for dynamically tuning a creativity of a language model (LM) comprising a pre-trained model and a creativity head. An example method includes: randomly initializing parameters of the creativity head, freezing all parameters of the pre-trained model; and fine-tuning the creativity of the LM by adjusting parameters of the creativity head using a training dataset configured to increase a likelihood of outputting one or more creative tokens as output from the LM, wherein at least one dynamic parameter is configured to adjust a token probability distribution output by a processing layer of the LM to generate an adjusted token probability distribution associated with a set of tokens and at least one additional dynamic parameter is configured to filter the set of tokens to generate a subset of tokens from which the new token is selected.

### BACKGROUND

### Field

Aspects of the present disclosure relate to dynamically tuning artificial intelligence models.

### Description of Related Art

Generative artificial intelligence (GenAI) refers to machine learning models that are able to create new content based on patterns and information learned from training data in combination with a user prompt. The user prompt provides instruction to the model on what new content to generate and how to generate that new content. Notably, the model is able to generate new content based on both the actual information (e.g., facts and knowledge) included in the training data, as well as patterns, insights, and model parameter weights learned from the training data.

GenAI models are able to generate new content in many different forms, including text, image, audio, and even video. For example, to facilitate text generation, some GenAI models are configured as language models (LMs). An LM is generally a type of machine learning model that is designed to understand, generate, and manipulate human language. More specifically, an LM is a probabilistic framework that determines the likelihood of a sequence of words or tokens. At its core, an LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

While LMs represent a transformative force in many industries by assimilating vast amounts of knowledge, these models are not without limitation. For example, while a powerful tool, a general-purpose LM may not be able to perform tasks related to generating specialized content that was not represented in the original training data or not enabled by its original configuration.

### SUMMARY

Certain aspects provide a method for dynamically tuning a creativity of a language model (LM), wherein the LM comprises: a pre-trained model configured to output a token probability distribution for a new token; and a creativity head configured to output a plurality of dynamic parameters configured to modify a prediction of the new token; and the method comprises: randomly initializing parameters of the creativity head; freezing all parameters of the pre-trained model; and fine-tuning the creativity of the LM by adjusting the parameters of the creativity head using a training dataset and a loss function configured to increase a likelihood of outputting one or more creative tokens as output from the LM, wherein at least one dynamic parameter is configured to adjust a token probability distribution output by a processing layer of the LM to generate an adjusted token probability distribution associated with a set of tokens and at least one additional dynamic parameter is configured to filter the set of tokens to generate a subset of tokens from which the new token is selected.

Certain aspects provide a method including: receiving an input to a language model, the language model comprising: a pre-trained model configured to output a token probability distribution for a new token, and a creativity head configured to output a plurality of dynamic parameters that is configured to modify a prediction of the new token; processing the input with the language model to generate an output, including: providing as input to the creativity head an output from an intermediate processing layer of the pre-trained model, providing as output from the creativity head the plurality of dynamic parameters, and generating an adjusted token probability distribution associated with a set of tokens, wherein a token probability distribution is adjusted based on a first dynamic parameter of the plurality of dynamic parameters; and generating the output comprising a creative token selected from the set of tokens.

Certain aspects provide a computer-implemented method for generating creative output. The method includes receiving, by an LM, a prompt configured to cause the LM to generate a new creative output comprising a plurality of tokens; determining a first value for a temperature parameter, a second value for a top k parameter, and a third value for a top p parameter associated with predicting a first new token of the plurality of tokens using a creativity head of the LM; predicting the first new token at least based on the first value for the temperature parameter, the second value for the top p parameter, and the third value for the top p parameter; determining a fourth value for the temperature parameter that is higher than the first value for the temperature parameter, a fifth value for the top p parameter, and a sixth value for the top p parameter associated with predicting a second new token; predicting the second new token based on the fourth value for the temperature parameter, the fifth value for the top p parameter, and the sixth value for the top p parameter; and sending the plurality of tokens comprising the first new token and second new token to a user interface.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of a conventional language model architecture.

FIG. 2 depicts an example of a creative language model architecture.

FIG. 3 depicts a flowchart for fine-tuning a creative language model.

FIG. 4 depicts a flowchart for generating creative output at run-time.

FIG. 5 depicts a graph of a creativity level distribution associated with an example creative output.

FIG. 6 depicts various examples of outputs based on different configurations of one or more dynamic parameters.

FIG. 7 depicts a method for dynamically tuning a creativity of an LM.

FIG. 8 depicts an example method 800 for generating creative outputs using a creative LM.

FIG. 9 depicts another example method for generating a creative output.

FIG. 10 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As described above, an LM is a type of machine learning model that is designed to understand, generate, and manipulate human language by predicting the next token in a token sequence based on previously predicted tokens. LMs may be characterized by various components and capabilities. For example, an LM may include a vocabulary that defines the set of all possible words or tokens that the model can recognize and use. This includes common words, punctuation, and possibly domain-specific jargon. LMs may also consider a context, which refers to the preceding words in a sentence or sequence that the model uses to predict the next word. Modern LMs often incorporate extensive context windows, leveraging entire sentences or even paragraphs.

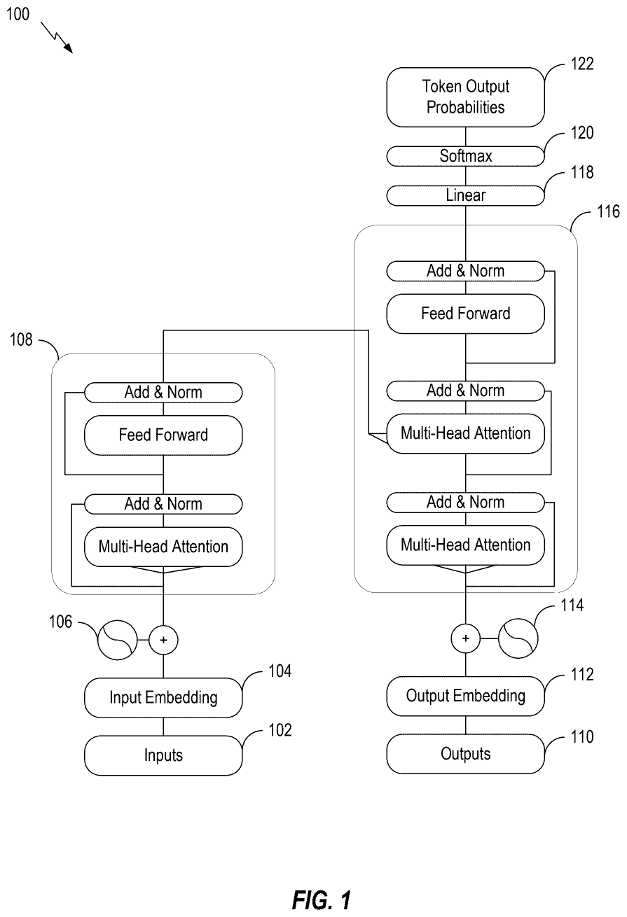

LMs may be implemented in various ways. For example, N-gram models predict the next word based on the previous N−1 words. Neural network-based LMs include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs. An example transformer architecture of a conventional LM is described in more detail with respect to FIG. 1.

LMs are often trained using large corpora of text. The training process involves adjusting the model's parameters to minimize the difference between its predicted word probabilities and the actual word sequences in the training data. This is typically done via techniques like maximum likelihood estimation and gradient descent.

Pre-training is the initial phase of training for generative LMs. Pre-training starts with an untrained model (e.g., a model that has randomly initialized weights), and trains it to predict a next token given a sequence of previous tokens. In the context of LMs, tokens may be units of text that the models process and generate. Tokens can represent individual characters, words, subwords, or even larger linguistic units, depending on the specific tokenization approach used. Tokenization refers to the process of segmenting text into meaningful units to capture its semantic and syntactic structure. Tokens act as a bridge between the raw text data and the numerical representations that LMs are able to work with.

Training data used to pre-train an LM often includes publicly available “raw text,” for example, from books, articles, websites, and/or the like. To be highly capable (e.g., have linguistic and world knowledge), this text may span a broad range of domains, genres, languages, etc. Eventually, by training on large amounts of text, the model learns to encode the structure of language in general (e.g., it learns, that “I like,” for example may be followed by a noun (e.g., patents) or a participle) as well as the knowledge included in the raw texts that the model was exposed to during training. For example, an LM may learn, that the sentence “George Washington was . . . ” is often followed by “the first president of the United States,” and hence has a representation of that piece of knowledge.

Although a pre-trained LM is, due to the knowledge it encodes, able to perform a variety of tasks, the model may lack specific knowledge that is not encoded in the training data. For example, a general-purpose LM (e.g., off-the-shelf LM) pre-trained on publicly-available data may not be able to respond, or may respond incorrectly, to certain types of prompts, such as a prompt requesting that the LM generate a joke or other creative output. In one aspect, the pre-trained LM may not be able to respond or may respond incorrectly given the information that is requested is not part of the generally available training data used to pre-train the LM. For example, the training data used during pre-training may not comprise examples of the type of creative output requested.

To address the shortcomings of general-purpose LMs, some conventional approaches seek to combine and orchestrate LM functionality with other sources of knowledge. For example, some conventional approaches use techniques to “fine-tune” LMs for specific domains. Fine-tuning LMs for specific domains involves adapting a pre-trained language model to generate domain-specific text and/or initiate or perform domain-specific tasks by training the pre-trained model on additional training datasets corresponding to the specific domain. This process allows the model to better understand and generate content that aligns with the particular domain and/or topic/area of interest.

It has been recognized, however, that an obstacle to effectively fine-tuning an LM for a particular domain is related to the insufficient amount of domain-specific training data available for training the LM. For example, LM fine-tuning may be dependent on the availability of large, high-quality, domain-specific datasets.

Some existing methods for generating training data may be used to manually (1) gather and integrate domain-specific data from various sources to generate a domain-specific dataset, (2) clean and filter the dataset to identify and rectify inconsistencies, errors, and/or irrelevant information within the dataset, (3) add metadata, tags, and/or annotations to the dataset to provide context and meaning to the raw data, (4) partition the dataset into training, validation, and testing datasets, and (5) ensuring that the datasets are compatible with an LM that is to be fine-tuned. While such methods for training data generation allow for creating training data that can then be used to fine-tune an LM to generate contextually appropriate responses to a variety of domain-specific prompts, manually generating training data using such existing methods may be cumbersome and time-consuming. Thus, it may take a very long time or even be impractical to develop LMs that understand and generate domain-specific data.

Further, managing this pipeline for generating training data and ensuring that the training data is always fresh, relevant, and includes high-quality data is a technical challenge, especially as the amount and/or types of training data needed increases. In some cases, these data generation and management challenges may be significant, for most of the effort involved in fine-tuning an LM for a specific domain may be tied up in generating and ensuring the quantity and quality of training data for the LM. Additional technical problems can occur with fine-tuning models such as incurring increased drain on computational resources (e.g., processing and memory storage) because all, or a majority, of parameters of the pre-trained LM must be adapted to the new training data used during fine-tuning. Furthermore, fine-tuning a pre-trained LM may result in catastrophic forgetting of knowledge already learned during the pre-training phase. Catastrophic forgetting occurs when a machine learning model rapidly loses its ability to perform previously learned tasks while in the process of learning new tasks. This can occur because the weights that encoded earlier learned knowledge get overwritten during the fine-tuning process.

Further, a pre-trained LM may not be able to generate creative output such as a joke because of its inherent training to predict the most likely next word or most likely sequence of words. In contrast to standard outputs characterized by high predictability, creative outputs, such as jokes, are characterized by outputs that are unexpected, yet still plausible (i.e., not nonsensical). In some instances, different parameters of the pre-trained LM can be changed to reduce the overall predictability associated with generating outputs. For example, as described above, an LM is configured to output a probability distribution associated with a set of tokens, where different tokens in the set of tokens correspond to different probabilities of being the next most likely token. “Temperature” is a parameter that works to adjust how sharp or flat the probability distribution becomes prior to sampling or selecting the next token. A sharper probability distribution makes it more likely for the model to choose the token with the highest probability. However, a flatter probability causes the probabilities across all of the different tokens to be more uniform, meaning it could be more equally likely to choose any token from the set of tokens.

After adjusting the probability distribution, LMs can be further tuned to generate more creative output by adjusting different sampling parameters, such as top p parameter and top k parameter. Sampling refers to the process of filtering the possible tokens and selecting the next token of the LM output. Top k sampling sorts the possible tokens by probability and keeps only the K highest probabilities, where K is a non-negative integer. Top p sampling also sorts tokens by probability but keeps the smallest set of tokens whose cumulative probability exceeds P, where P is a minimum probability. In sum, top k sampling acts as a fixed truncation of the probability distribution originally generated by the LM, while top p sampling adapts to the shape of the distribution. These sampling methods are often combined to control the randomness and quality of the token sampling. Accordingly, lower values for temperature, top p, and top k parameters results in a more predictable and standardized, while higher values for those parameters can result in output that is less predictable and more diverse.

However, a major technical problem of tuning the temperature, top p, and top k parameters is that the values are determined for the entire generation process across all tokens that are predicted as part of the final LM output. Because of this, the LM may select multiple tokens in row that correspond to less predictability, thereby resulting in output that may be creative in the sense that the sequence of tokens is unexpected, but does not actually make sense in terms of generating a plausible output. Moreover, in the example of generating creative outputs such as jokes, the LM may select tokens that are creative and plausible but not actually funny. For example, a joke is not funny if every single word is unexpected, rather jokes are typically characterized by phrases or concepts that are expected that then have an unexpected modification or twist at some point in the joke. If the values for temperature, top p, and top k are the same every time a new token is predicted, introducing a twist into the output is very unlikely because there will likely be no contrast between portions that are expected and other portions that are unexpected.

Accordingly, aspects of the present disclosure provide apparatuses, methods, processing systems, and computer-readable mediums that overcome the aforementioned technical problems. In particular, the present disclosure is directed to a creative LM that is configured to dynamically tune a creativity level associated with predicting tokens throughout the LM output generation process. As described herein, a creative LM comprises a creativity head that has been integrated with a pre-trained LM. The creativity head is configured to dynamically output values for the temperature, top p, and top k parameters that will adjust the token prediction for each next token that is predicted by the LM until the generation process is completed. The creative LM is trained on a limited training dataset comprising examples of creative outputs, such as examples of jokes. Other examples of creative outputs include stories, such as novels, plays, scripts, or screenplays, poems, advertisements, recipes, and brainstorm ideas. It should be appreciated that creative outputs can comprise written examples, audio-based examples, visual (image or video) examples, and/or audio-visual examples.

In some aspects, the training process is accomplished by freezing all of the layers/parameters of the pre-trained model and only updating the layers/parameters of the creativity head. Alternatively, in some aspects, the training process is accomplished by freezing a subset of layers/parameters of the pre-trained model.

Once the creative LM is trained, the creative LM is configured to predict a next token by first adjusting the probability distribution using the dynamically determined temperature parameter and then applying a top k sampling adjusted by the dynamically determined top k parameter and a top p sampling adjusted by the dynamically determined top p parameter. In this manner, the creative LM is able to generate creative output comprising a series of tokens that contain both standard and creative tokens at different locations throughout the creative output.

Accordingly, the present disclosure overcomes the technical problem of costly data gathering normally required by fine-tuning because only a limited dataset is needed to fine-tune the creative LM. Specifically, because the pre-trained model of the creative LM is frozen, the fine-tuning process only needs to update the creativity head (which has significantly fewer parameters than the pre-trained model). This means that much less data is required to accurately and efficiently train the creativity head to produce quality output.

Furthermore, because the pre-trained model layers are frozen and only the creativity head layers are updated, the process of fine-tuning the creative LM uses significantly less computational resources as compared to conventional fine-tuning processes. Further, by freezing the pre-trained model and only updating the creativity head during the fine-tuning process, the technical problem of catastrophic forgetting is avoided. This is because the parameters of the pre-trained model are not overwritten during the fine-tuning process of the creative LM.

Aspects of the creative LM described herein also overcome the technical problem of generating nonsensical output that is typically associated with adjusting the temperature, top p, and top k parameters to reduce the predictability of the tokens. In particular, the creative LM is able to dynamically determine values for these parameters whereas conventionally such parameters are static. In this manner, the creative output can comprise a variety of standard and creative tokens at different token locations of the creative output. Furthermore, the creativity head can learn different patterns of creativity level distributions to output creative output that is characterized by twists at the right token locations to make the creative output unexpected, but still plausible and meaningful.

Additionally, aspects of the present disclosure can be beneficially adapted to generate creative output for various modalities, including in image and audio formats. This is because a creativity head can be integrated into other types of generative models, including LM models, acoustic models, image generators, audio generators, and video generators.

Finally, the creativity head described herein can be adapted to generate a wide variety of parameters, not just the temperature, top p, and top k parameters. For example, the creativity head can be configured to dynamically determine repetition or frequency penalties, response length or a maximum number of tokens, n-gram penalties, and/or beam widths used in beam searches, which are parameters than can be used to further control the creativity of the creative LM.

### Conventional Language Models

FIG. 1 depicts an example of a conventional model architecture for an LM that is trained to understand and generate human language. In particular, FIG. 1 depicts pre-trained model 100 comprising a plurality of processing layers that are configured to receive various inputs and output token probabilities based on those inputs. Pre-trained model 100 is a model that has already undergone a general training process on a large universal training dataset.

As one example, pre-trained model 100 comprises an input embedding layer 104 configured to generate embeddings of inputs 102. Input embedding layer 104 generates embeddings of inputs 102 by converting raw input tokens of inputs 102 into vector representations that can be processed by subsequent processing layers. Vector representations are a useful format to represent inputs 102 because the vectors are able to capture semantic relationships between tokens such that similar words end up with similar vector representations. A positional encoding 106 is also embedded with the input embeddings prior to being processed by layer block 108. Layer block 108 comprises processing layers such as a multi-head attention network, addition & normalization layers, and a feed forward network.

Multi-head attention networks allow models to process different segments of an input sequence in parallel. For example, the attention mechanism is split into several parallel heads that are each configured to learn different relationship patterns in the data. The outputs from each head are then combined. Add & norm layers comprise a residual connection (“Add”) and a layer normalization step (“Norm”). The residual connection preserves information by adding the input directed to the transformed output, while the layer normalization helps to scale summed values to have consistent statistical properties. In other words, the “Add” step help to prevent information from being lost during transformation, and the “Norm” step helps keep output values in a reasonable range as they are processed through downstream layers. A feed forward network is a neural network layer that independently processes each position in the sequence by applying different linear transformations with a nonlinear activation in between the linear transformations. This causes the input vector to transform into a higher-dimensional space and then back to its original dimension.

Pre-trained model 100 also comprises an output embedding layer 112 that is configured to generate embeddings of outputs 110. A positional encoding 114 is also embedded with output embeddings prior to being further processed by layer block 116. Positional encodings are used in transformer-based models, like pre-trained model 100, to provide information about the order of tokens in a sequence. This allows pre-trained model 100 to process sequences of tokens while maintaining awareness of token order. Layer block 116 comprises different processing layers, such as multi-head attention networks, addition & normalization layers, and a feed forward network.

Output from layer block 108 is provided as input to layer block 116, for example, at the second multi-head attention network. Output from layer block 108 is considered intermediate output of pre-trained model 100 because it is output at an intermediary layer and further processed by subsequent layers within pre-trained model 100.

Output from layer block 116 is further processed by linear layer 118. Linear layers are configured to apply a weighted matrix to layer input and adding a bias vector, which causes the inputs to be mapped to a different dimension without non-linearity. A Softmax layer 120 is then applied to the output from linear layer 118 and is configured to generate token output probabilities 122. Softmax layers convert raw model outputs into probability distributions by exponentiating each input and then normalizing the inputs so that all values sum to one. It is typically used as the final layer in machine learning models, such as language models and other classification-type models. It should be appreciated that pre-trained model 100 may comprise any number of processing layers and any configuration of those processing layers to facilitate its functionality as a language model. Pre-trained model 100 may be a third-party off-the-shelf model.

As described above, conventional language models are configured to predict the most likely next token as part of a sequence of tokens that make up a final generative output. For example, the language model will predict the most likely next word in a sentence that is being generated as an answer to a user input question. Because of this structure and training, conventional LMs generate output that is highly predictable and standardized. Different aspects of the model can be adapted to alter how the language model predicts the next token and generates the final output. However, such modifications are static during the entire token generation process in conventional models, meaning that the modifications are applied universally to each next token that is predicted. Accordingly, the present disclosure is directed to systems and methods that allow for a model to dynamically tune different aspects of the token prediction throughout the entire generation process to enhance the creativity and dynamic range of the output.

### Introduction to Creative Language Models

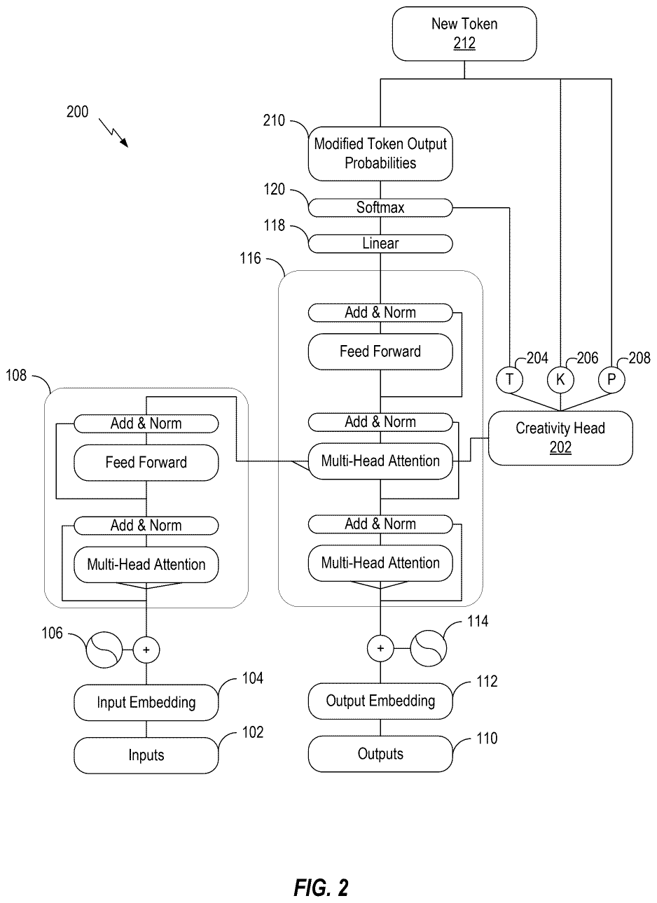

FIG. 2 depicts an example of a creative LM architecture. In particular, creative LM 200 comprises pre-trained model 100 of FIG. 1 that has been modified to include a creativity head 202.

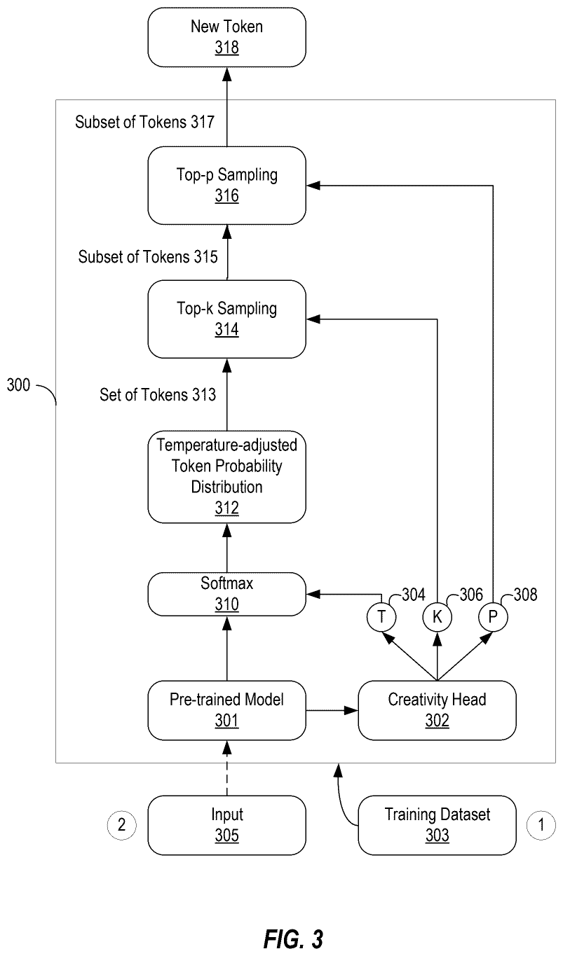

Creative LM 200 is an LM that has an increased likelihood of creative tokens being predicted by the model as compared to standard LMs. A creative token is a token that would not have a high likelihood of being predicted based on a standard set of static model parameters and general training associated with pre-trained model 301. In other words, a creative token is one that would be highly unlikely but for the intervention of the creativity head added to the model architecture and corresponding fine-tuning process as described in more detail with respect to FIG. 3. In contrast to a creative token, a standard token is a token that does have a high likelihood of being predicted based on standard parameters and general training. In one aspect, a high creativity level is associated with a high likelihood of predicting creative tokens while a low creativity level is associated with a low likelihood of predicting creative tokens or high likelihood of predicting standard tokens. The creativity level can be based on any one of: a temperature level, a top k parameter, a top p parameter, or some combination of those model parameters.

Creativity head 202 is a set of additional processing layers that are integrated with pre-trained model 100 to enhance the capability of pre-trained model 100 generating creative output. As shown in FIG. 2, creative LM 200 comprises a configuration in which creativity head 202 receives input from an intermediate processing layer of pre-trained model 100 (e.g., multi-head attention network of layer block 116). In some aspects, the creativity head is connected to the second attention layer output in order to allow it to refer to the tokens that were generated so far. It should be appreciated that creativity head 202 can be configured to receive output from any intermediate processing layer that allows it to refer to tokens that were previously generated, depending on the configuration and type of pre-trained model that is used as the base model.

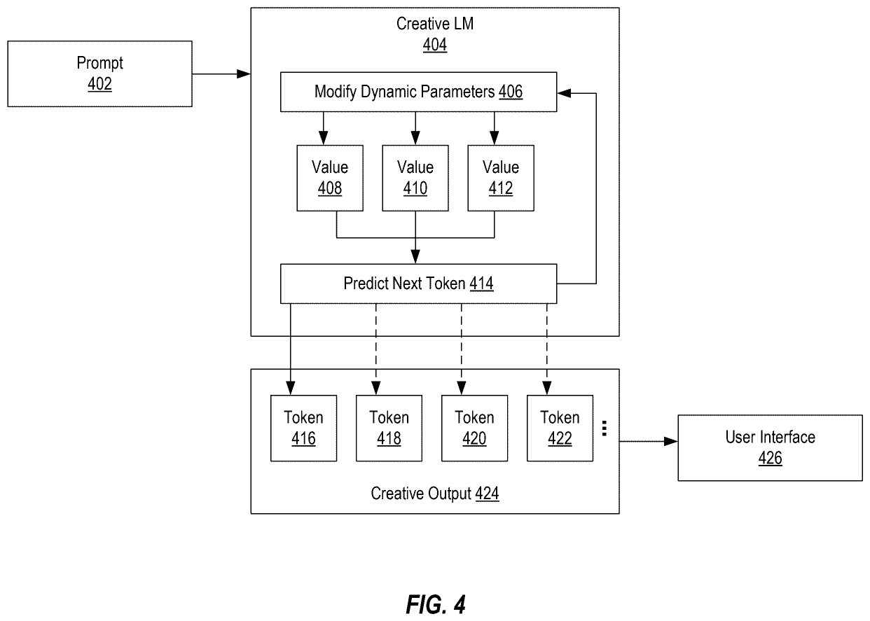

As shown in FIG. 2, creativity head 202 is configured to output a plurality of dynamic parameters, such as dynamic parameter 204, dynamic parameter 206, and dynamic parameter 208, which are described in more detail below with respect to FIG. 3. These dynamic parameters are configured to modify the token output probabilities so that creative LM 200 generates modified token output probabilities 210. These dynamic parameters also control how new token 212 is selected based on the modified token output probabilities 210. The run-time process of generating creative outputs in this manner is described in more detail with respect to FIG. 4.

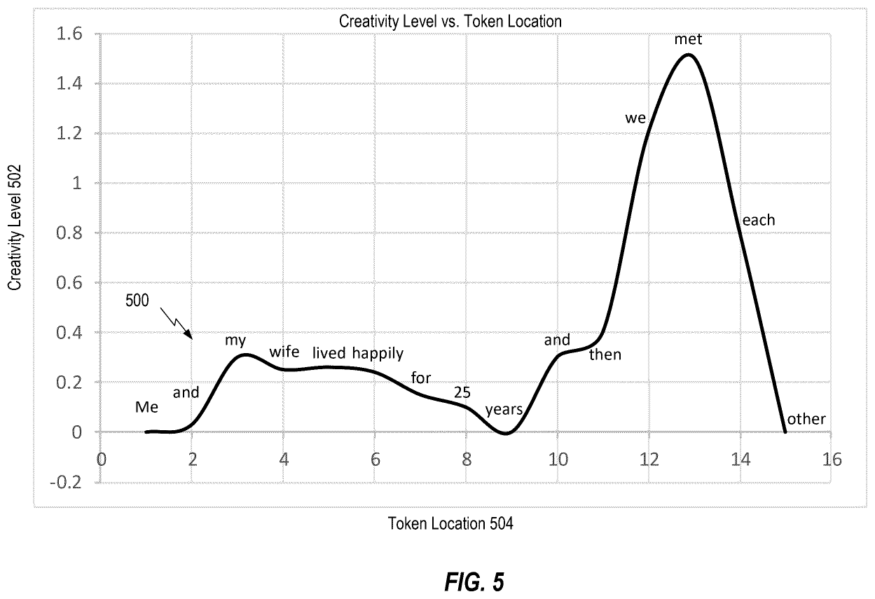

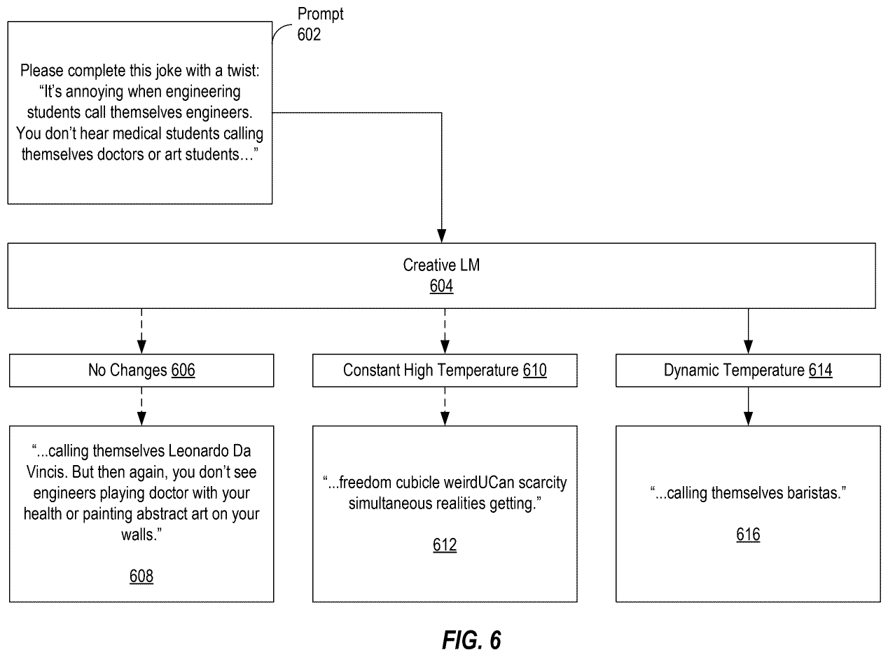

New values for each of the dynamic parameters are calculated for each next token that is being predicted, thereby allowing the model to dynamically adjust the creativity level of new tokens. In this manner, the creative output comprises a first predicted token that may have a low creativity level while a second predicted token may have a high creativity level. These creativity levels are described in more detail below with respect to FIG. 5, which illustrates a creativity level distribution of an example creative output. Additional examples of creative output generated based on different adjustments to the dynamic parameters are illustrated in FIG. 6.

### Fine-Tuning a Creative Language Model

FIG. 3 depicts a flowchart for fine-tuning a creative LM to generate creative output, such as described and depicted with respect to FIG. 2.

As shown in FIG. 3, creative LM 300 comprises pre-trained model 301, creativity head 302, and Softmax layer 310. In some aspects, creative LM 300 is an example of creative LM 200 with pre-trained model 301 depicted as an example of pre-trained model 100 and creativity head 302 depicted as an example of creativity head 202. Pre-trained model 301 is configured generate output that is used as input to Softmax layer 310, although other final output layers can be used in other aspects. Creativity head 302 is configured to output a plurality of dynamic parameters configured to modify a prediction of the new token. Creative LM 300 is configured so that output from pre-trained model 301 is provided as input to creativity head 302. Accordingly, Softmax layer 310 receives output from both pre-trained model 301 and creativity head 302.

As part of the fine-tuning process, all the parameters of the pre-trained model 301 are frozen, which means they will not be updated in the fine-tuning process. Additionally, the parameters of the creativity head 302 are initialized (e.g., randomly in some aspects). Next, the creative LM 300 is fine-tuned by modifying one or more processing layers of the creativity head 302. This is achieved by fine-tuning creative LM 300 on training dataset 303 and modifying a loss function used when training creative LM 300 on training dataset 303 to increase a likelihood of outputting one or more creative tokens from creative LM 300. It should be appreciated that the loss function can be configured as any loss function suitable for a regression task, such as Mean Squared Error (MSE), Mean Absolute Error (MAE), Hubor loss, Log-Cosh loss, or Quantile loss.

In this example, training dataset 303 comprises examples of creative output, such as a plurality of token sets in which at least one token of the token set is a creative token. In some aspects, training dataset 303 comprises a plurality of jokes such that creative LM 300 is fine-tuned to generate creative output configured as jokes. Training dataset 303 may also include other examples of creative outputs, as novels, plays, scripts, screenplays, poems, advertisements, recipes, and/or brainstorm ideas. It should be appreciated that training dataset 303 can comprise written examples, audio-based examples, visual (image or video) examples, and/or audio-visual examples.

Once creative LM 300 has been fine-tuned, creativity head 302 is able to output one or more dynamic parameters that will allow creative LM 300 to generate creative outputs in the following manner:

After performing the fine-tuning process, creativity head 302 is now able output dynamic parameter 304 which is configured to adjust the token probability distribution output by Softmax layer 310. In some aspects, dynamic parameter 304 is a temperature parameter. Thus, by applying dynamic parameter 304, Softmax layer 310 is configured to generate temperature-adjusted token probability distribution 312 corresponding to set of tokens 313. The temperature parameter directly affects how the Softmax function processes the output generated by pre-trained model 301. A final processing layer of pre-trained model 301 is configured to generate a set of logits, or vector representations, which will be further processed to predict the next token. For example, the standard Softmax formula is:

$$softmax ( {x}_{i} ) = exp ( {x}_{i} ) / \sum exp ( {x}_{j} ) \qquad ( 1 )$$

When a temperature parameter (T) is introduced, the Softmax formula becomes:

$$softmax ( {x}_{i , T} ) = exp ( \frac{{x}_{i}}{T} ) / \sum exp ( \frac{{x}_{j}}{T} ) \qquad ( 2 )$$

Thus, the scaling of the probability distribution by the temperature parameter occurs before the exponential function in the Softmax formula which produces the following effects on the probability distribution. When T<1, dividing by a smaller number causes the differences between logits to become larger. Applying the exponent then amplifies the differences between probabilities. Overall, this causes the probability distribution to become sharper and form a peak at high probability tokens. In other words, the lower the temperature parameter, the probability of choosing the highest probability token is increased. The higher the temperature parameter, the higher the probability of choosing a lower probability token.

When T=1, the Softmax layer 310 is configured as a standard Softmax layer and preserves the original relationships between logits. When T>1, dividing by a larger number makes the differences between logits smaller. Applying the exponent reduces the differences between the probabilities. This causes the probability distribution to become more uniform. Tokens with more uniform probabilities have more equal chances of being sampled as part of predicting the next token. This means that tokens that, under a standard Softmax layer, would have been less probable of being chosen (e.g., tokens that had lower/more different probabilities) now have a more equal chance of being sampled as tokens than would have otherwise under the standard Softmax function. In other words, a higher temperature will make it more likely that a creative (or unexpected token) is sampled.

Additionally, creativity head 302 is also now able to output at least one dynamic parameter, such as dynamic parameter 306 and/or dynamic parameter 308, to filter set of tokens 313 into subset of tokens 315 and/or subset of tokens 317. New token 318 may be selected from subset of tokens 315 or subset of tokens 317 depending on the configuration. For example, in some aspects, dynamic parameter 306 is configured as a top k parameter that filters tokens based on top k sampling 314. As briefly described above, top k sampling sorts the tokens associated with the temperature-adjusted probability by probability and keeps on the K highest probability tokens, where K is a non-negative integer. This essentially truncates the ends of the probability distribution and creates a hard cutoff in how many tokens can be considered. Top k sampling also performs a normalization to renormalize the remaining probabilities to sum to one. Finally, tokens are sampled from the truncated probability distribution and added to subset of tokens 315. When K is increased, more tokens are available for sampling, including tokens with lower probabilities. Such tokens are typically considered to be more creative tokens because they are the tokens that would be less likely to be predicted under standard conditions.

In some aspects, dynamic parameter 308 is a top p parameter and is configured to filter tokens based on top p sampling 316. As briefly described above, top p sampling also sorts the tokens by probability but keeps the smallest set of tokens whose cumulative probability exceeds P, which is a number between 0 and 1. For example, if P-0.9, creative LM would sort tokens by their probabilities in order of highest to lowest. Tokens would be sampled and added to subset of tokens 317 until the cumulative probabilities reached 0.9 (or 90% of the total probability mass). New token 318 is then selected from subset of tokens 317.

Accordingly, in some aspects, either top k sampling 314 or top p sampling 316 are performed to filter set of tokens 313 into subsets. Alternatively, a combination of top k sampling 314 and top p sampling 316 are used to filter set of tokens 313 into subsets. For example, as shown in FIG. 3, top k sampling 314 and top p sampling 316 are performed in series such that top k sampling is applied to set of token 313 to generate subset of tokens 315 and top p sampling 316 is applied to subset of tokens 315 to generate subset of tokens 317. Thus, the original set of tokens is iteratively filtered based on the number of parameters generated by creativity head 302 (e.g., filtered n times based on n parameters output by creativity head 302). New token 318 is then selected from subset of tokens 317. In other aspects, top p sampling 316 is performed first, followed by top k sampling 314, such that new token 318 is selected from subset of tokens 315 associated with top k sampling 314.

As shown in FIG. 3, by performing top k sampling first, the top k parameter can be increased to allow for a greater number of tokens to be included in subset of tokens 315. Then, performing top p sampling after top k sampling allows for a more uniform probability distribution across subset of tokens 317. Thus, by dynamically adjusting each of the aforementioned parameters, the creativity level of each next token that is predicted can be dynamically tuned, allowing for a wide variety of standard and creative tokens to be generated as part of the creative output of creative LM 300.

In some aspects, after performing the fine-tuning process, creativity head 302 is also able to generate values for dynamic parameters associated with repetition penalties, maximum token lengths, N-gram penalties, and beam search widths. Repetition penalties are weights applied during the token sampling process that reduce the probability of selecting tokens that have appeared recently in the generated text, helping to prevent redundant or cyclical output patterns. Constraints on maximum token lengths are configured as hard limits on the total number of tokens that can be generated in a response. To encourage more creative output, the maximum token length can be increased to allow for more content to be generated. N-gram penalties are sampling techniques that reduce the likelihood of generating sequences of N consecutive tokens that have appeared previously in the text, helping to avoid repetitive phrases and improve output diversity. Beam search width defines the number of parallel candidate sequences maintained during text generations, where larger widths allow for the LM to explore more possibilities in the output generation.

### Generating Creative Output

FIG. 4 depicts a flowchart for generating creative output. Once creative LM 404 is fine-tuned to generate creative output, as described with respect to FIG. 3, creative LM 404 is able to receive prompt 402, which is configured to cause creative LM 404 to generate creative output 424. Prompt 402 comprises instructions on how to generate creative output 424, such as a topic, a format, and/or type of creative output. For example, prompt 402 may comprise instructions to generate a one-line joke about a dog and a cat. In other instances, prompt 402 may comprise instructions to generate a long-form satire about fruit trees growing in the same garden. Prompt 402 can be generated by human users and/or generated by another LM.

In some aspects, creative output 424 is generated one token at a time, wherein the dynamic parameters of creative LM 404 are modified each time a new token is generated. Thus, to generate token 416, the dynamic parameters are configured to generate a first value 408 for the temperature parameter, a second value 410 for the top k parameter, and a third value 412 for the top p parameter. These values are then used to predict the next token at 414.

Then, to generate token 418, the values of the dynamic parameters are modified again at 406, such that each dynamic parameter has a new value. These new values are used to predict the next token at 414. This process is repeated for each new token, such as token 420 and token 422, until the generation of creative output 424 is completed. This process is distinct from and improved upon that of conventional LMs, where each new token would be predicted using the same parameter values for every token that is predicted.

In some aspects, new values are determined for all of the dynamic parameters (e.g., for 408, 410, and 412 in this example). In other aspects, the values for a subset of the dynamic parameters is updated for each new token (e.g., one or two of 408, 410, and 412 in this example). Thus, the creative LM 404 can be configured to determine which dynamic parameters to update in each iteration and then determine the values for those dynamic parameters selected for updating. Once creative output 424 is complete, creative output 424 can be transmitted to and caused to be displayed at user interface 426.

Creative LM 404 can leverage its trained dynamic creativity in various fields where there is a need to maintain coherent sentence structure and ideas while introducing new, fresh angles and thinking outside the box. In particular, creative content that comprises breakthroughs and new ideas must include unpredictable twists. For example, when writing stories, creative LM 404 is able to introduce a surprising plot twist. When writing poems, a new angle or metaphor could be introduced. When writing patents, a new connection between two unrelated topics might produce a highly creative idea. Additional areas that require similar creativity include advertising, filmmaking, and culinary arts recipes. Accordingly, a non-exhaustive list of examples of creative outputs that creative LM 404 may generate includes: jokes, novels, plays, scripts, screenplays, poems, advertisements, and recipes. Creative LM 404 may also be used during brainstorming sessions for generating new ideas in a variety of topics and tasks. It should be appreciated that creative outputs can comprise written examples, audio-based examples, visual (image or video) examples, and/or audio-visual examples.

### Creativity Level Distributions

FIG. 5 depicts a graph of a creativity level distribution associated with an example creative output. In particular, creative output 500 comprises a plurality of tokens, namely: [Me] [and] [my] [wife] [lived] [happily] [for] [years] [and] [then] [we] [met] [each] [other]. In some aspects, creative output 500 is an example of creative output 424 of FIG. 4. Each token has a token location 504 indicating a position within the sequence of creative output 500. Each token is also associated with a creativity level 502.

In some aspects, creativity level distributions can be based on instructions included in a prompt to the creative LM. For example, a prompt could comprise instructions to generate a joke with the punchline at the end of the joke, such that the LM generates with tokens at the highest creativity level in an ending portion of the creative output, as shown in the example illustrated in FIG. 5. In another example, a prompt could comprise instructions to generate an introduction to a speech with a first portion of the introduction comprising a comical, attention-grabbing statement. In other aspects, the creativity level distribution is generated during a run-time process corresponding to generating the creative output, where each next creativity level is determined based on a previously predicted token and previous creativity level.

FIG. 5 depicts creativity levels that are scaled between 0 and 1.6. It should be appreciated, however, that creativity levels can be mapped to any type or range of scale. According to the scale depicted in FIG. 5, [Me] has a creativity level of 0, [and] has a creativity level of 0.1, [my] has a creativity level of 0.3 and so on. Notably, tokens in token locations 1-11 and 15 are associated with lower creativity levels between 0 and 0.4, while tokens in token locations 12-14 correspond to higher creativity levels above 0.8, with a maximum creativity level being associated with [met] in token location 13. Tokens corresponding to lower creativity levels are considered to be standard tokens while tokens with higher creativity levels are considered to be creative tokens.

During the process of generating creative output 500 by a creative LM, the creative head of the creative LM generates values for the dynamic parameters that cause the creative LM to predict more standard tokens with lower creativity levels for a beginning portion and middle portion of creative output 500. Then, during an ending portion of creative output, the creativity head generated values for the dynamic parameters that caused the creative LM to predict creative tokens associated with higher creativity levels.

[Met] is considered to be a creative token with a high creativity level in this example because it is an unexpected word in its location. This is in contrast to the token [other], which has a low creativity level because the word “other” is very likely to be predicted to come after the word “each” in normal conversation. In this manner, creative output 500 is configured as a joke because the creative token [met] is likely to amuse and catch a person off-guard who might have been expecting the sentence to be “Me and my wife lived happily for 25 years and then we divorced each other.” Creative output thus comprises the right creative token at the right token position in order to deliver plausible but creative meaning to the output.

### Example Creative Outputs

FIG. 6 depicts various examples of outputs based on different configurations of one or more dynamic parameters.

In particular, FIG. 6 depicts prompt 602, which may be an example of prompt 402 of FIG. 4. Prompt 602 comprises the following instructions: “Please complete this joke with a twist: ‘It's annoying when engineering students call themselves engineers. You don't hear medical students calling themselves doctors or art students . . . ”” Prompt 602 is provided to creative LM 604, which may be an example of creative LM 404 of FIG. 4. In one aspect, creative LM 604 is configured to dynamically determine a new value for the temperature parameter for each new token that is predicted as part of the creative output that is generated by creative LM 604.

If the temperature parameter is configured to remain at T=1 (meaning that the token probability distribution is standard and static throughout the generation process) at 606 (in other words, where T experiences no changes during the generation of output in response to a prompt), creative LM 604 would behave as a conventional LM and generate output 608. Output 608 comprises a completion to prompt 602, namely: “calling themselves Leonardo Da Vinci's. But then again, you don't see engineers playing doctor with your health or painting abstract art on your walls.” Here, output 608 comprises a plausible completion to the prompt, but does not necessarily add a “twist” as part of a joke as instructed by prompt 602.

If the temperature parameter is configured as a constant high temperature at 610, e.g., T>1, creative LM 604 would generate a creative but nonsensical output, such as output 612. For example, output 612 comprises the following completion to prompt 602: “freedom cubicle weirdUCan scarcity simultaneous realities getting.” This output comprises all creative tokens resulting in an output that does not make sense.

If temperature parameter is dynamically determined for each new token at 614, where sometimes T>1, sometimes T=1, and sometimes T<1, the creative LM 604 is able to generate creative output such as output 616. Here, output 616 creatively and comically completes prompt 602 with: “calling themselves baristas.” This is plausible because there is a trope that struggling artists work additional jobs such as bartenders to make ends meet, but it is also creative and funny because an expected output would have said “art students calling themselves artists” to follow the pattern provided by prompt 602. Instead, creative LM 604 output a creative token comprising “baristas” to play on the struggling artist trope that their “actual jobs” are baristas, not artists.

While FIG. 6 illustrates various examples of outputs in the context of a prompt 602 comprising instructions for creative LM 604 to generate jokes, it should be appreciated that the systems and methods described herein for dynamically determining one or more different parameters for creative LM 604 can be applied to a variety of tasks and modalities. For example, creative LM 604 could be instructed to generate long-form creative outputs such as books, novels, reports, or essays that are creative and include an unexpected plot twist or unexpected characterization of an event.

### Example Method for Dynamically Tuning a Creativity of an LM

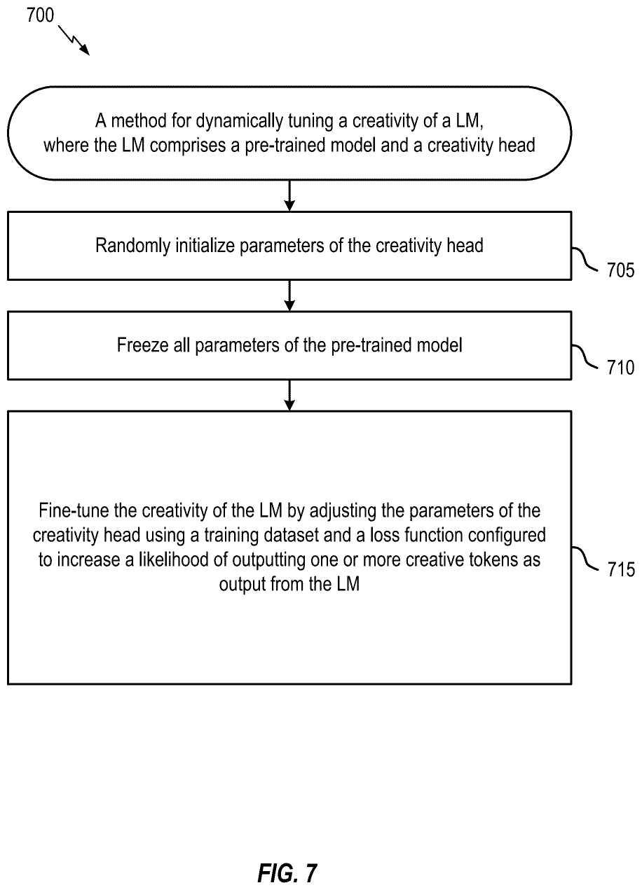

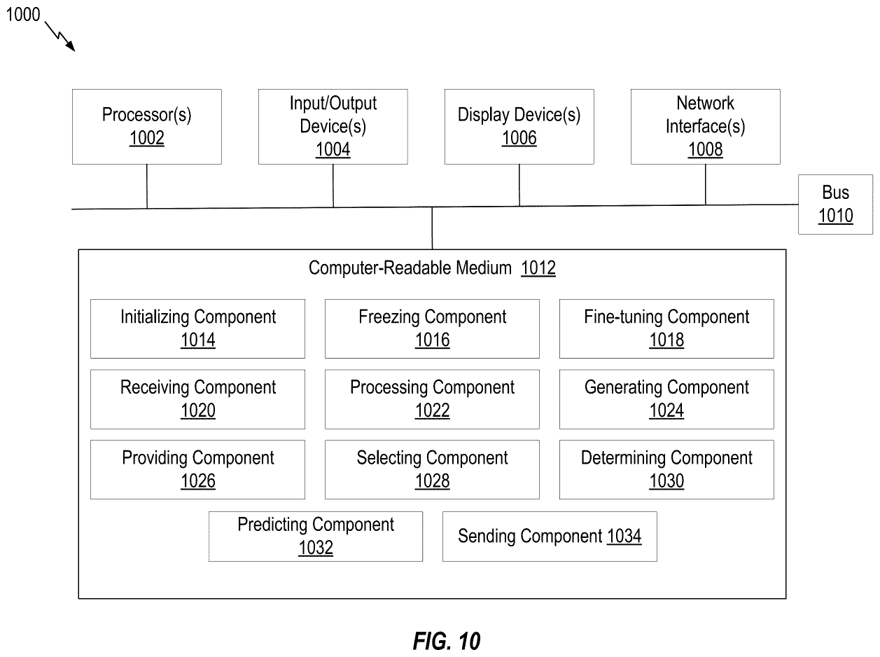

FIG. 7 depicts an example method 700 for dynamically tuning a creativity of an LM, such as creative LM 300 of FIG. 3. In this example, the LM comprises: a pre-trained model, like pre-trained model 301, configured to output a token probability distribution for a new token; and a creativity head, like creativity head 302, configured to output a plurality of dynamic parameters, such as dynamic parameter 304, dynamic parameter 306, and dynamic parameter 308, which are configured to modify a prediction of the new token, like new token 318. In one aspect, method 700 can be implemented by processing system 1000 of FIG. 10.

Method 700 begins at block 705 with randomly initializing parameters of the creativity head. In some aspects, block 705 is performed by initializing component 1014 of FIG. 10.

Method 700 then proceeds to block 710 with freezing all parameters of the pre-trained model. In some aspects, block 710 is performed by freezing component 1016 of FIG. 10.

For example, freezing component 1016 may freeze the parameters of pre-trained model 301 of FIG. 3. Because the pre-trained model layers are frozen and only the creativity head layers are updated, the fine-tuning process of method 700 significantly reduces the amount of computational resources as compared to conventional fine-tuning processes that update all of the parameters of a given model, including the pre-trained model. Further technical benefits are achieved by freezing the pre-trained model and only updating the creativity head during the fine-tuning process in that catastrophic forgetting of previously learned knowledge is prevented. This is because the parameters of the pre-trained model are not overwritten during the fine-tuning process of the creative LM.

Method 700 then proceeds to block 715 with fine-tuning the creativity of the LM by adjusting the parameters of the creativity head using a training dataset and a loss function configured to increase a likelihood of outputting one or more creative tokens as output from the LM. Thus, method 700 overcomes the technical problem of costly data gathering normally required for fine-tuning because only a limited dataset is needed to fine-tune the creativity head of creative LM. That is, because the pre-trained model of the creative LM is frozen, the fine-tuning process only needs to update the creativity head, which has significantly fewer parameters than the pre-trained model. This means that much less data is required to accurately and efficiently train the creativity head to produce quality output.

In some aspects, at least one dynamic parameter is configured to adjust a token probability distribution output by a processing layer of the LM to generate an adjusted token probability distribution, associated with a set of tokens and at least one additional dynamic parameter is configured to filter the set of tokens to generate a subset of tokens from which the new token is selected.

In some aspects, block 715 is performed by fine-tuning component 1018 of FIG. 10. By way of example, fine-tuning component 1018 may adjust the parameters of creativity head 302 of FIG. 3 using training dataset 303, wherein dynamic parameter 304 is configured to adjust the token probability distribution output by Softmax layer 310 to generate temperature-adjusted token probability distribution 312. Additionally, dynamic parameter 306 and/or dynamic parameter 308 may be used to filter (through top k sampling 314 and/or top p sampling 316) to filter the set of tokens and generate one or more subsets of tokens from which new token 318 is selected.

Accordingly, aspects of method 700 described herein also overcome the technical problem of generating nonsensical output that is typically associated with adjusting the temperature, top p, and top k parameters to reduce the predictability of the tokens. In particular, the creative LM is able to dynamically determine values for these parameters, causing what are usually static parameters, to be dynamic parameters that are changeable for each next token that is predicted. In this manner, the creative output can comprise a variety of standard and creative tokens at different token locations of the creative output. Furthermore, the creativity head can learn different patterns of creativity level distributions to output creative output that is characterized by twists at the right token locations to make the creative output unexpected but still plausible and meaningful.

In some aspects, the parameters of the pre-trained model remain static during generation of the new token.

In some aspects, the plurality of dynamic parameters comprise one or more of: a temperature parameter, such as dynamic parameter 304 of FIG. 3, a top p parameter, such as dynamic parameter 306 of FIG. 3, or a top k parameter, such as dynamic parameter 308 of FIG. 3. Additionally, the creativity head can be adapted to generate a wide variety of parameters, not just the temperature, top p, and top k parameters. For example, the creativity head can be configured to dynamically determine repetition or frequency penalties, dynamically determine response length or a maximum number of tokens, dynamically determine n-gram penalties, and/or dynamically determine beam widths used in beam searches, which are parameters than can be used to further control the creativity of the creative LM.

In some aspects, the training dataset comprises a token set in which at least one token of the token set is a creative token, like “met” illustrated in FIG. 5. Accordingly, method 700 is able to fine-tune a creative LM to generate creative output that is characterized by comprising at least one correct creative token at a correct token location so that the creative output retains plausibility and meaning while providing an unexpected twist. Additional technical benefits can be achieved because aspects of method 700 can be adapted to different modalities (image, audio, etc.) to generate creative output, not just in text-based formats, but also in image and audio formats. This is because a creativity head can be easily and efficiently added to other types of generative models, including LM models, acoustic models, image generators, audio generators, and video generators.

In some aspects, the creativity head receives an output of an intermediate processing layer, such as from layer block 116 of FIG. 1, of the pre-trained model.

In some aspects, the intermediate processing layer comprises an attention layer of the pre-trained model.

In some aspects, the attention layer is a multi-head attention layer, such as the multi-head attention network of layer block 116 of FIG. 1.

Note that FIG. 7 is just one example of a method, and other methods including fewer, additional, or alternative operations are possible consistent with this disclosure.

### Example Method for Generating Creative Output

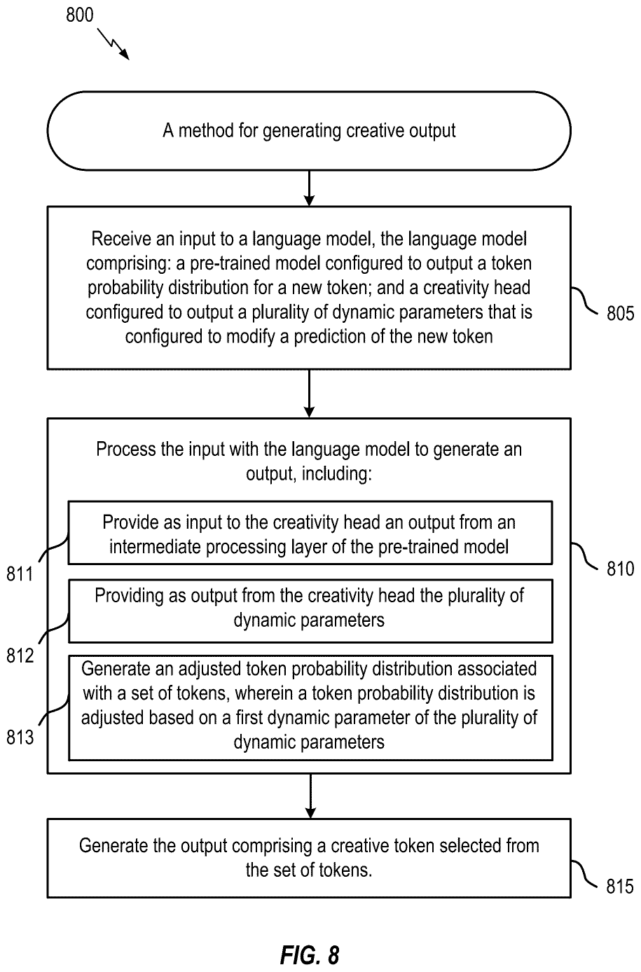

FIG. 8 depicts an example method 800 for generating creative outputs using a creative LM. In one aspect, method 800 can be implemented by the processing system 1000 of FIG. 10.

Method 800 begins at block 805 with receiving an input to a language model, the language model comprising: a pre-trained model configured to output a token probability distribution for a new token; and a creativity head configured to output a plurality of dynamic parameters that is configured to modify a prediction of the new token. In some aspects, block 805 may be performed by receiving component 1020 of FIG. 10. By way of example, receiving component 1020 may facilitate creative LM 300 of FIG. 3 receiving input 305 of FIG. 3, where creative LM 300 comprises pre-trained model 301 and creativity head 302.

Method 800 then proceeds to block 810 with processing the input with the language model to generate an output. The language model processes the input by providing as input to the creativity head an output from an intermediate processing layer of the pre-trained model (block 811). Next, the language model provides, as output from the creativity head, the plurality of dynamic parameters (block 812). Subsequently, the language model generates an adjusted token probability distribution associated with a set of tokens, wherein a token probability distribution is adjusted based on a first dynamic parameter of the plurality of dynamic parameters (block 813).

In some aspects, block 810 is performed by processing component 1022 of FIG. 10. For example, processing component 1022 may process input 305 of FIG. 3 with creative LM 300 to generate an output such as new token 318. Providing component 1026 of FIG. 10 may be used to provide output from pre-trained model 301 as input to creativity head 302 and provide dynamic parameter 304, dynamic parameter 306, and dynamic parameter 308 as output from creativity head 302 to Softmax layer 310. Generating component 1024 of FIG. 10 may then be used to generate temperature-adjusted token probability distribution 312, which has been adjusted based on dynamic parameter 304.

Method 800 then proceeds to block 815 with generating the output comprising a creative token selected from the set of tokens. In some aspects, block 815 is performed by generating component 1024 of FIG. 10, for example, to generate new token 318 of FIG. 3 as output from creative LM 300.

In some aspects, the first dynamic parameter, like dynamic parameter 304 of FIG. 3, is a temperature parameter.

In some aspects, method 800 further includes generating a first subset of tokens selected from the set of tokens based on a second dynamic parameter of the plurality of dynamic parameters. For example, generating component 1024 of FIG. 10 may be used to generate subset of tokens 315 of FIG. 3 and/or subset of tokens 317 based on dynamic parameter 306 and/or dynamic parameter 308.

In some aspects, method 800 further includes selecting the creative token from the first subset of tokens.

In some aspects, the second dynamic parameter is a top k parameter, such as dynamic parameter 306.

In some aspects, the set of dynamic model parameters comprise one or more of: a temperature parameter, a top p parameter, or a top k parameter.

In some aspects, the output is configured as a joke.

In some aspects, method 800 further includes generating a second subset of tokens selected from the first subset of tokens based on a third dynamic parameter of the plurality of dynamic parameters. For example, generating component 1024 of FIG. 10 may be used to generate subset of tokens 317 of FIG. 3 based on dynamic parameter 308.

In some aspects, method 800 further includes selecting the creative token from the second subset of tokens.

In some aspects, the third dynamic parameter is a top p parameter, such as dynamic parameter 308 of FIG. 3.

In some aspects, method 800 further includes determining a creativity level, such as creativity level 502 of FIG. 5, for the new token based on the plurality of dynamic parameters output by the creativity head.

Accordingly, aspects of method 800 are able to dynamically determine values for dynamic parameters whereas conventionally such parameters are static. In this manner, the creative output can comprise a variety of standard and creative tokens at different token locations of the creative output. Furthermore, the creativity head can learn different patterns of creativity level distributions to output creative output that is characterized by twists at the right token locations to make the creative output unexpected, but still plausible and meaningful. By dynamically determining the values for temperature, top p, and top k, method 800 overcomes the technical problem of generating nonsensical output when such parameters are static over the entire generation process.

Additionally, aspects of the present disclosure can be beneficially adapted to generate creative output for various modalities, including in image and audio formats. This is because a creativity head can be integrated into other types of generative models, including LM models, acoustic models, image generators, audio generators, and video generators.

Note that FIG. 8 is just one example of a method, and other methods including fewer, additional, or alternative operations are possible consistent with this disclosure.

### Another Example Method for Generating Creative Output

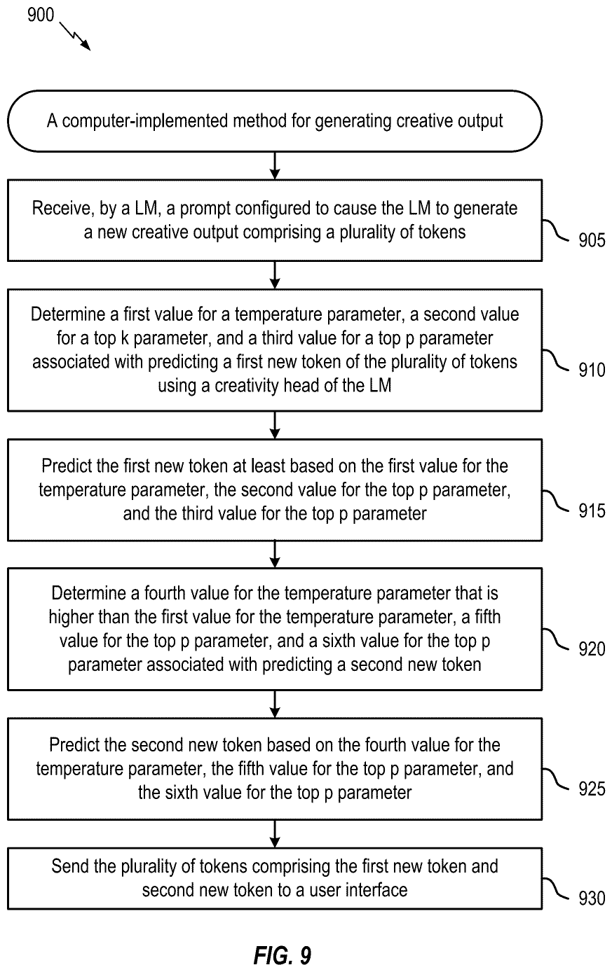

FIG. 9 depicts an example method 900 for generating a creative output. In one aspect, method 900 can be implemented by the processing system 1000 of FIG. 10.

Method 900 begins at block 905 with receiving, by an LM, a prompt (e.g., prompt 402) configured to cause the creative LM to generate a new creative output comprising a plurality of tokens. In some aspects, block 905 is performed by receiving component 1020 of FIG. 10. For example, receiving component 1020 may facilitate creative LM 404 receiving prompt 402 which is configured to cause creative LM 404 to generate creative output 424 comprising a plurality of tokens, such as token 416, token 418, token 420, and token 422.

Method 900 then proceeds to block 910 with determining a first value for a temperature parameter, a second value for a top k parameter, and a third value for a top p parameter associated with predicting a first new token of the plurality of tokens using a creativity head of the LM. In some aspects, block 910 is performed by determining component 1030 of FIG. 10. For example, determining component 1030 may be used to determine value 408 of FIG. 10 for a temperature parameter, value 410 of FIG. 4 for a top k parameter, and value 412 for a top p parameter, which are all associated with predicted the next token at 414.

Method 900 then proceeds to block 915 with predicting the first new token at least based on the first value for the temperature parameter, the second value for the top p parameter, and the third value for the top p parameter. In some aspects, block 915 is performed by predicting component 1032 of FIG. 10. For example, predicting component 1032 may predict token 416 of FIG. 4.

Method 900 then proceeds to block 920 with determining a fourth value for the temperature parameter that is higher than the first value for the temperature parameter, a fifth value for the top p parameter, and a sixth value for the top p parameter associated with predicting a second new token, such as token 418. In some aspects, block 910 is performed by determining component 1030 of FIG. 10.

Method 900 then proceeds to block 925 with predicting the second new token based on the fourth value for the temperature parameter, the fifth value for the top p parameter, and the sixth value for the top p parameter. In some aspects, block 925 is performed by predicting component 1032 of FIG. 10 to predict token 418 of FIG. 4.

Method 900 then proceeds to block 930 with sending the plurality of tokens comprising the first new token and second new token to a user interface, such as user interface 426 of FIG. 4. In some aspects, block 930 is performed by sending component 1034 of FIG. 10.

In some aspects, method 900 further includes determining a creativity level distribution comprising a plurality of creativity levels defined across a plurality of token locations corresponding to the plurality of tokens of the new creative output.

An example of the plurality of tokens is illustrated in FIG. 5: “[Me] [and] [my] [wife] [lived] [happily] [for] [years] [and] [then] [we] [met] [each] [other]”. The first value for a temperature parameter, the second value for a top k parameter, and the third value for a top p parameter associated with predicting the first new token of the plurality of tokens is determined based on identifying a particular creativity level (e.g., 0) from the plurality of creativity levels defined at a particular token location (e.g., token location 1) corresponding to the first new token (e.g., [Me]).

In some aspects, method 900 further includes generating the creativity level distribution based on the prompt.

In some aspects, the LM comprises at least: a creativity head configured to dynamically determine values for the temperature parameter, the top k parameter, and the top p parameter associated with the LM; and a final processing layer configured to output token probability distributions for the tokens based on previous token outputs and the temperature parameter, the top k parameter, and the top p parameter dynamically determined by creativity head.

Thus, aspects of method 900 overcome the technical problem of generating nonsensical output that is typically associated with adjusting the temperature, top p, and top k parameters to reduce the predictability of the tokens. In particular, the creative LM is able to dynamically determine values for these parameters whereas conventionally such parameters are static. In this manner, the creative output can comprise a variety of standard and creative tokens at different token locations of the creative output. Furthermore, the creativity head can learn different patterns of creativity level distributions to output creative output that is characterized by twists at the right token locations to make the creative output unexpected, but still plausible and meaningful. Accordingly, aspects of method 900 can leverage the dynamic creativity of a creative LM in various fields where there is a need to maintain coherent sentence structure and ideas while introducing new, fresh angles and thinking outside the box.

Note that FIG. 9 is just one example of a method, and other methods including fewer, additional, or alternative operations are possible consistent with this disclosure.

### Example Processing System for Dynamically Tuning a Creativity of an LM and Generating Creative Output

FIG. 10 depicts an example processing system 1000 configured to perform various aspects described herein, including, for example, method 700 as described above with respect to FIG. 7, method 800 as described above with respect to FIG. 8, and/or method 900 as described above with respect to FIG. 9.

Processing system 1000 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processors 1002, one or more input/output devices 1004, one or more display devices 1006, one or more network interfaces 1008 through which processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of a one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1006 may be configured to display a graphical user interface.

Network interface(s) 1008 provide processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random access memory (RAM), or a nonvolatile memory, such as nonvolatile random access memory (NVRAM), or the like. In this example, computer-readable medium 1012 includes initializing component 1014, freezing component 1016, fine-tuning component 1018, receiving component 1020, processing component 1022, generating component 1024, providing component 1026, selecting component 1028, determining component 1030, predicting component 1032, and sending component 1034. Processing of the components 1014-1034 may enable and cause the processing system 1000 to perform: the method 700 described with respect to FIG. 7, or any aspect related to it; the method 800 described with respect to FIG. 8, or any aspect related to it; and the method 900 described with respect to FIG. 9, or any aspect related to it.

In certain embodiments, initializing component 1014 is configured to randomly initialize parameters of the creativity head, as described in FIG. 7 with reference to block 705. In certain embodiments, freezing component 1016 is configured to freeze all parameters of the pre-trained model, as described in FIG. 7 with reference to block 710. In certain embodiments, fine-tuning component 1018 is configured to fine-tune the creativity of the LM by adjusting the parameters of the creativity head using a training dataset and a loss function configured to increase a likelihood of outputting one or more creative tokens as output from the LM, wherein at least one dynamic parameter is configured to adjust a token probability distribution output by a processing layer of the LM to generate an adjusted token probability distribution associated with a set of tokens and at least one additional dynamic parameter is configured to filter the set of tokens to generate a subset of tokens from which the new token is selected, as described in FIG. 7 with reference to block 715.

In certain embodiments, receiving component 1020 is configured to receive an input to a language model, the language model comprising: a pre-trained model configured to output a token probability distribution for a new token; and a creativity head configured to output a plurality of dynamic parameters that is configured to modify a prediction of the new token, as described in FIG. 8 with reference to block 805. In certain embodiments, processing component 1022 is configured to process the input with the language model to generate an output, including: providing as input to the creativity head an output from an intermediate processing layer of the pre-trained model; providing as output from the creativity head the plurality of dynamic parameters; and generating an adjusted token probability distribution associated with a set of tokens, wherein a token probability distribution is adjusted based on a first dynamic parameter of the plurality of dynamic parameters, as described in FIG. 8 with reference to block 810. In certain embodiments, generating component 1024 is configured to generate the output comprising a creative token selected from the set of tokens, as described in FIG. 8 with reference to block 815.

In certain embodiments, receiving component 1020 is configured to receive, by an LM, a prompt configured to cause the LM to generate a new creative output comprising a plurality of tokens, as described in FIG. 9 with reference to block 905. In certain embodiments, determining component 1030 is configured to determine a first value for a temperature parameter, a second value for a top k parameter, and a third value for a top p parameter associated with predicting a first new token of the plurality of tokens using a creativity head of the LM, as described in FIG. 9 with reference to block 910. In certain embodiments, predicting component 1032 is configured to predict the first new token at least based on the first value for the temperature parameter, the second value for the top p parameter, and the third value for the top p parameter, as described in FIG. 9 with reference to block 915. In certain embodiments, determining component 1030 is configured to determine a fourth value for the temperature parameter that is higher than the first value for the temperature parameter, a fifth value for the top p parameter, and a sixth value for the top p parameter associated with predicting a second new token, as described in FIG. 9 with reference to block 920. In certain embodiments, predicting component 1032 is configured to predict the second new token based on the fourth value for the temperature parameter, the fifth value for the top p parameter, and the sixth value for the top p parameter, as described in FIG. 9 with reference to block 925. In certain embodiments, sending component 1034 is configured to transmit the plurality of tokens comprising the first new token and second new token to a user interface, such as one of display devices 1006 of FIG. 10, as described in FIG. 9 with reference to block 930.

Note that FIG. 10 is just one example of a processing system consistent with aspects described herein, and other processing systems having additional, alternative, or fewer components are possible consistent with this disclosure.

### Example Clauses

Implementation examples are described in the following numbered clauses:

Clause 1: A method for dynamically tuning a creativity of an LM, wherein the LM comprises: a pre-trained model configured to output a token probability distribution for a new token, and a creativity head configured to output a plurality of dynamic parameters configured to modify a prediction of the new token, and the method comprises: randomly initializing parameters of the creativity head; freezing all parameters of the pre-trained model; and fine-tuning the creativity of the LM by adjusting the parameters of the creativity head using a training dataset and a loss function configured to increase a likelihood of outputting one or more creative tokens as output from the LM, wherein at least one dynamic parameter is configured to adjust a token probability distribution output by a processing layer of the LM to generate an adjusted token probability distribution associated with a set of tokens and at least one additional dynamic parameter is configured to filter the set of tokens to generate a subset of tokens from which the new token is selected.

Clause 2: The method of Clause 1, wherein the parameters of the pre-trained model remain static during generation of the new token.

Clause 3: The method of any one of Clauses 1-2, wherein the plurality of dynamic parameters comprise one or more of: a temperature parameter, a top p parameter, or a top k parameter.

Clause 4: The method of any one of Clauses 1-3, wherein the training dataset comprises a token set in which at least one token of the token set is a creative token.

Clause 5: The method of any one of Clauses 1-4, wherein the creativity head receives an output of an intermediate processing layer of the pre-trained model.

Clause 6: The method of Clause 5, wherein the intermediate processing layer comprises an attention layer of the pre-trained model.

Clause 7: The method of Clause 6, wherein the attention layer is a multi-head attention layer.

Clause 8: A method for generating creative content comprising: receiving an input to a language model, the language model comprising: a pre-trained model configured to output a token probability distribution for a new token; and a creativity head configured to output a plurality of dynamic parameters that is configured to modify a prediction of the new token; processing the input with the language model to generate an output, including: providing as input to the creativity head an output from an intermediate processing layer of the pre-trained model, providing as output from the creativity head the plurality of dynamic parameters, and generating an adjusted token probability distribution associated with a set of tokens, wherein a token probability distribution is adjusted based on a first dynamic parameter of the plurality of dynamic parameters; and generating the output comprising a creative token selected from the set of tokens.

Clause 9: The method of Clause 8, wherein the first dynamic parameter is a temperature parameter.

Clause 10: The method of any one of Clauses 8-9, further comprising: generating a first subset of tokens selected from the set of tokens based on a second dynamic parameter of the plurality of dynamic parameters; and selecting the creative token from the first subset of tokens.

Clause 11: The method of Clause 10, wherein the second dynamic parameter is a top k parameter.

Clause 12: The method of Clause 10, further comprising: generating a second subset of tokens selected from the first subset of tokens based on a third dynamic parameter of the plurality of dynamic parameters; and selecting the creative token from the second subset of tokens.

Clause 13: The method of Clause 12, wherein the third dynamic parameter is a top p parameter.

Clause 14: The method of Clause 11, wherein the set of dynamic model parameters comprise one or more of: a temperature parameter, a top p parameter, or a top k parameter.

Clause 15: The method of Clause 11, wherein the output is configured as a joke.

Clause 16: The processing system of any one of Clauses 8-15, further comprising determining a creativity level for the new token based on the plurality of dynamic parameters output by the creativity head.

Clause 17: A computer-implemented method for generating creative output, the method comprising: receiving, by an LM, a prompt configured to cause the LM to generate a new creative output comprising a plurality of tokens; determining a first value for a temperature parameter, a second value for a top k parameter, and a third value for a top p parameter associated with predicting a first new token of the plurality of tokens using a creativity head of the LM; predicting the first new token at least based on the first value for the temperature parameter, the second value for the top p parameter, and the third value for the top p parameter; determining a fourth value for the temperature parameter that is higher than the first value for the temperature parameter, a fifth value for the top p parameter, and a sixth value for the top p parameter associated with predicting a second new token; predicting the second new token based on the fourth value for the temperature parameter, the fifth value for the top p parameter, and the sixth value for the top p parameter; and sending the plurality of tokens comprising the first new token and second new token to a user interface.

Clause 18: The computer-implemented method of Clause 17, further comprising determining a creativity level distribution comprising a plurality of creativity levels defined across a plurality of token locations corresponding to the plurality of tokens of the new creative output, wherein the first value for a temperature parameter, the second value for a top k parameter, and the third value for a top p parameter associated with predicting the first new token of the plurality of tokens is determined based on identifying a particular creativity level from the plurality of creativity levels defined at a particular token location corresponding to the first new token.

Clause 19: The computer-implemented method of Clause 18, further comprising generating the creativity level distribution based on the prompt.

Clause 20: The method of any one of Clauses 17-19, wherein the LM comprises at least: a creativity head configured to dynamically determine values for the temperature parameter, the top k parameter, and the top p parameter associated with the LM; and a final processing layer configured to output token probability distributions for the tokens based on previous token outputs and the temperature parameter, the top k parameter, and the top p parameter dynamically determined by creativity head.

Clause 21: A processing system, comprising: memory comprising computer-executable instructions; and one or more processors configured to execute the computer-executable instructions and cause the processing system to perform a method in accordance with any one of Clauses 1-20.

Clause 22: A processing system, comprising means for performing a method in accordance with any one of Clauses 1-20.

Clause 23: A non-transitory computer-readable medium storing program code for causing a processing system to perform the steps of any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for dynamically tuning a creativity of a language model (LM), wherein:
the LM comprises:
a pre-trained model configured to output a token probability distribution for a new token; and
a creativity head configured to output a plurality of dynamic parameters configured to modify a prediction of the new token, and
the method comprises:
randomly initializing parameters of the creativity head;
freezing all parameters of the pre-trained model; and
fine-tuning the creativity of the LM by adjusting the parameters of the creativity head using a training dataset configured to increase a likelihood of outputting one or more creative tokens as output from the LM, wherein at least one dynamic parameter is configured to adjust a token probability distribution output by a processing layer of the LM to generate an adjusted token probability distribution associated with a set of tokens and at least one additional dynamic parameter is configured to filter the set of tokens to generate a subset of tokens from which the new token is selected.

2. The computer-implemented method of claim 1, wherein the parameters of the pre-trained model remain static during generation of the new token.

3. The computer-implemented method of claim 1, wherein the plurality of dynamic parameters comprise one or more of: a temperature parameter, a top p parameter, or a top k parameter.

4. The computer-implemented method of claim 1, wherein the training dataset comprises a token set in which at least one token of the token set is a creative token.

5. The computer-implemented method of claim 1, wherein the creativity head receives an output of an intermediate processing layer of the pre-trained model.

6. The computer-implemented method of claim 5, wherein the intermediate processing layer comprises an attention layer of the pre-trained model.

7. The computer-implemented method of claim 6, wherein the attention layer is a multi-head attention layer.

8. A processing system comprising one or more memories comprising computer-executable instructions; and one or more processors configured to execute the computer-executable instructions and cause the processing system to:
receive an input to a language model, the language model comprising:
a pre-trained model configured to output a token probability distribution for a new token; and
a creativity head configured to output a plurality of dynamic parameters that is configured to modify a prediction of the new token;
process the input with the language model to generate an output, including:
providing as input to the creativity head an output from an intermediate processing layer of the pre-trained model;
providing as output from the creativity head the plurality of dynamic parameters;
generate an adjusted token probability distribution associated with a set of tokens, wherein a token probability distribution is adjusted based on a first dynamic parameter of the plurality of dynamic parameters; and
generate the output comprising a creative token selected from the set of tokens.

9. The processing system of claim 8, wherein the first dynamic parameter is a temperature parameter.

10. The processing system of claim 8, wherein the processing system is further caused to:
generate a first subset of tokens selected from the set of tokens based on a second dynamic parameter of the plurality of dynamic parameters; and
select the creative token from the first subset of tokens.

11. The processing system of claim 10, wherein the second dynamic parameter is a top k parameter.

12. The processing system of claim 10, wherein the processing system is further caused to:
generate a second subset of tokens selected from the first subset of tokens based on a third dynamic parameter of the plurality of dynamic parameters; and
select the creative token from the second subset of tokens.

13. The processing system of claim 12, wherein the third dynamic parameter is a top p parameter.

14. The processing system of claim 11, wherein the set of dynamic model parameters comprise one or more of: a temperature parameter, a top p parameter, or a top k parameter.

15. The processing system of claim 11, wherein the output is configured as a joke.

16. The computer-implemented method of claim 2, further comprising determining a creativity level for the new token based on the plurality of dynamic parameters output by the creativity head.

17. A computer-implemented method for generating creative output, the method comprising:
receiving, by a language model (LM), a prompt configured to cause the LM to generate a new creative output comprising a plurality of tokens;
determining a first value for a temperature parameter, a second value for a top k parameter, and a third value for a top p parameter associated with predicting a first new token of the plurality of tokens using a creativity head of the LM;
predicting the first new token at least based on the first value for the temperature parameter, the second value for the top p parameter, and the third value for the top p parameter;
determining a fourth value for the temperature parameter that is higher than the first value for the temperature parameter, a fifth value for the top p parameter, and a sixth value for the top p parameter associated with predicting a second new token;
predicting the second new token based on the fourth value for the temperature parameter, the fifth value for the top p parameter, and the sixth value for the top p parameter; and
sending the plurality of tokens comprising the first new token and second new token to a user interface.

18. The computer-implemented method of claim 17, further comprising determining a creativity level distribution comprising a plurality of creativity levels defined across a plurality of token locations corresponding to the plurality of tokens of the new creative output,
wherein the first value for a temperature parameter, the second value for a top k parameter, and the third value for a top p parameter associated with predicting the first new token of the plurality of tokens is determined based on identifying a particular creativity level from the plurality of creativity levels defined at a particular token location corresponding to the first new token.

19. The computer-implemented method of claim 18, further comprising generating the creativity level distribution based on the prompt.

20. The computer-implemented method of claim 17, wherein the LM comprises at least:
a creativity head configured to dynamically determine values for the temperature parameter, the top k parameter, and the top p parameter associated with the LM; and
a final processing layer configured to output token probability distributions for the tokens based on previous token outputs and the temperature parameter, the top k parameter, and the top p parameter dynamically determined by creativity head.
